(19) United States
(12) Patent Application Publication
(10) Pub. No.: US 2026/0363831 A1
(43) Pub. Date: Nov. 19, 2026

(54) TRANSFER APPARATUS FOR ORTHODONTIC APPLIANCES AND RELATED METHODS OF MANUFACTURING

(71) Applicant: Solventum Intellectual Properties Company, Maplewood, MN (US)

(72) Inventors: Michael K. DOMROESE, Woodbury, MN (US); David K. CINADER, Woodbury, MN (US); Thomas MUELLER, Gauting (DE)

(21) Appl. No.: 19/135,788

(22) PCT Filed: Nov. 10, 2023
(86) PCT No.: PCT/IB2023/061398

§ 371 Date: Jun. 4, 2025

Related U.S. Application Data
(60) Provisional application No. 63/432,481, filed on Dec. 14, 2022.

(51) Int. Cl. A61C 7/14

(52) U.S. Cl. CPC A61C 7/146

(57) ABSTRACT

Method of making a transfer apparatus includes providing a physical mockup having a shape that corresponds to a positive shape of a patient's dental arch and one or more orthodontic appliances connected to the arch via one or more sprues. A transfer apparatus may be formed over the physical mockup, with the transfer tray representing a negative replica of at least a portion of the mockup. The transfer apparatus may be used to seat the appliance on a patient's dental arch, after which point the appliance can be separated from transfer apparatus and bonded to the associated tooth.

### BACKGROUND

in Orthodontic appliances are used in orthodontic treatments for moving one or more teeth from an initial position (sometimes referred to as malposition or malocclusion) to a desired position in a patient's dentition. For example, the patient's teeth may be moved such that their labial sides are aligned with each other to achieve or maximize an aesthetically pleasant appearance of the overall dentition. Further in some cases one or more teeth may be moved to correct a malocclusion. The movement of teeth is typically achieved in traditional orthodontic braces by a pre-biased archwire which is attached via brackets to the teeth, and which applies a force to the teeth toward the desired position over a longer period. The ends of orthodontic archwires are often connected to small appliances known as buccal tubes that are, in turn, secured to the patient's molar teeth. In many instances, a set of brackets, buccal tubes and an archwire is provided for each of the upper and lower dental arches.

Orthodontic treatment may also involve the use of alignment trays, such as clear or transparent, polymer-based tooth positioning trays, often referred to as clear tray aligners (CTAs). For example, orthodontic treatment with CTAs may include forming a tray having shells that engage one or more teeth. Each shell may be deformed from an initial position of a tooth, e.g., a malocclusion position. The deformed position of a respective shell of the CTA may apply a force to a respective tooth toward a desired position of the tooth that is an intermediate position between the initial position and a final position resulting from the orthodontic treatment.

In some examples, small attachments may be bonded to the teeth to improve force application or achieve desired tooth movements. In many types of orthodontic techniques, the precise position of the appliances, be they attachments or brackets, on the teeth is an important factor for helping to ensure that the teeth move to their intended final positions. Proper placement of attachments may ensure proper engagement and interaction of the attachment with one or more CTAs. The design of the attachment may provide a desired physical leverage which creates a desired force on a tooth to produce a specific movement of the tooth during treatment. Attachments are typically constructed of varying materials, shapes and sizes, and can be bonded to the labial or lingual surfaces of teeth in order to interact with CTAs and removable appliances in a variety of different ways. Attachments can be applied to a patient's teeth prior to treatment with aligners. Attachments may also be fabricated prior to attachment to the tooth surface. Attachments may also be substantially assembled at the orthodontic practitioner's office prior to, or in conjunction with, positioning on the patient's tooth (e.g., molded composites, etc.).

Generally, bondable orthodontic appliances may be attached to the teeth by a direct bonding procedure or an indirect bonding procedure. In the direct bonding procedure, the appliance is commonly grasped with a pair of tweezers or other hand instrument and placed by the practitioner on the surface of the tooth in its desired location, using a quantity of adhesive to fix the appliance to the tooth. In the indirect bonding procedure, a transfer tray is constructed with wall sections having a shape that matches the configuration of at least part of the patient's dental arch, and appliances such as orthodontic attachments are releasably connected to the tray at certain, predetermined locations. After an adhesive is applied to the base of each appliance, the tray is placed over the patient's teeth and remains in place until the adhesive has hardened. The tray is then detached from the teeth as well as from the appliances such that the appliances previously connected to the tray are bonded to the respective teeth at their intended, predetermined locations.

Indirect bonding techniques offer several advantages over direct bonding techniques. For example, it is possible with indirect bonding techniques to bond a plurality of appliances to a patient's dental arch simultaneously, thereby avoiding the need to bond each appliance in individual fashion. Additionally, or alternatively, the transfer tray may improve accuracy of attachment placement. The increased placement accuracy of the appliances that is often afforded by indirect bonding procedures helps ensure that the patient's teeth are moved to their proper, intended positions at the conclusion of treatment. Due to their small size and shape, attachments may be difficult to manipulate for placement in a transfer tray.

### SUMMARY OF THE INVENTION

Prior methods of bonding attachments to teeth commonly relied on either the placement of preformed attachments in an indirect bonding tray or the creation of an attachment directly on the tooth surface. Both methods introduced various errors in the bonding process, appliance fidelity, and treatment effectiveness. Attachments are typically difficult to handle when preformed given their relatively small dimensions, leading to difficulties placing in a tray or directly on teeth. Failures to properly place lead to misdirected forces and suboptimal engagement with the associated CTA. Attempts to create transfer apparatuses along with attachments result in difficult geometries for additive manufacturing and challenges of excess customization that can slow commercial operations. Forming an appliance on the surface of the tooth is fraught with its own challenges, typically centered on the difficulty of ensuring an adequate bond to the tooth surface and sufficient material strength in the formed attachment body. The present inventors sought to solve these and other problems by providing a preformed appliance that could be formed with a transfer apparatus.

In one aspect, the present disclosure provides a physical mockup for creating a transfer apparatus. The mockup comprises a representation of at least a portion of a dental arch, the dental arch including a plurality of teeth, each tooth including an occlusal surface, a lingual surface, and a labial surface. One or more teeth include an appliance frangibly connected to said tooth at the bonding surface of said tooth.

In another aspect, the present disclosure provides a method for creating a transfer tray for one or more orthodontic appliances. The method includes providing a physical mockup for creating a transfer apparatus, the mockup comprising a representation of at least a portion of a dental arch of a patient, the dental arch including a plurality of teeth, each tooth including at least two of an occlusal surface, a lingual surface, and a labial surface. One or more teeth include an appliance frangibly connected to said tooth at the bonding surface of said tooth, each tooth with a connected appliance defining a bonding tooth. The method includes forming a tray over the mockup.

In another aspect, the present disclosure provides a system for indirect bonding of orthodontic appliances. The system comprises a transfer body defining a shell configured to receive an outer surface of a tooth of a dental arch and includes an interior surface substantially conforming to the contour of at least one tooth of the dental arch. The transfer body defines at least one recess within the shell; and an orthodontic appliance in the recess. The appliance includes a base for bonding the appliance to the tooth and a body includes a perimeter, wherein a least a portion of the perimeter is surrounded by a channel in the transfer body.

For the purpose of this specification, the term “virtual” refers to a three-dimensional computer representation of an object, preferably based on a mathematical representation of a three-dimensional shape in data form and processable by a computer. Such virtual objects in the form of data including their visualizations (for example wire frames or digital renderings) are widely known in the field of Computer Aided Design (CAD).

For the purpose of the present specification the term “set of” refers to a “plurality of”.

As used herein, “orthodontic appliance” includes orthodontic brackets, orthodontic attachments, buccal tubes, orthodontic bands, buttons, and cleats, in particular orthodontic brackets and orthodontic attachments.

As used herein, “hardenable” is descriptive of a material or composition that can be cured (e.g., polymerized or crosslinked) or at least partially solidified, for example, by removing solvent (e.g., by evaporation and/or heating); heating to induce polymerization and/or crosslinking; irradiating to induce polymerization and/or crosslinking; and/or by mixing one or more components to induce polymerization and/or crosslinking. As used herein, “hardened” refers to a material or composition that has been cured (e.g., polymerized or crosslinked) or solidified.

As used herein as a modifier to a property or attribute, the term “generally”, unless otherwise specifically defined, means that the property or attribute would be readily recognizable by a person of ordinary skill but without requiring absolute precision or a perfect match (e.g., within +/−20% for quantifiable properties). The term “substantially”, unless otherwise specifically defined, means to a high degree of approximation (e.g., within +/−10% for quantifiable properties) but again without requiring absolute precision or a perfect match. Terms such as same, equal, uniform, constant, strictly, and the like, are understood to be within the usual tolerances or measuring error applicable to the particular circumstance rather than requiring absolute precision or a perfect match.

As used herein, “anterior teeth” includes the central incisors, lateral incisors, canines, and first bicuspids.

As used herein, “posterior teeth” includes the second bicuspid, the first molar, the second molar, and the third molar (if patient still retains wisdom teeth).

“Mesial” means in a direction toward the center of the patient's curved dental arch.

“Distal” means in a direction away from the center of the patient's curved dental arch.

“Occlusal” means in a direction toward the outer tips of the patient's teeth and is inclusive of “incisal”.

“Gingival” means in a direction toward the patient's gums or gingiva.

“Facial” means in a direction toward the patient's cheeks or lips.

“Lingual” means in a direction toward the patient's tongue.

The above summary of the present disclosure is not intended to describe each disclosed embodiment or every implementation of the present disclosure. The description that follows more particularly exemplifies illustrative embodiments. In several places throughout the application, guidance is provided through lists of examples, which examples can be used in various combinations. In each instance, the recited list serves only as a representative group and should not be interpreted as an exclusive list.

### BRIEF DESCRIPTION OF THE FIGURES

FIG. 1 is a perspective view of a physical mockup for creating a transfer apparatus according to embodiments of the disclosure;

FIG. 2 is a perspective view of the physical mockup of FIG. 1, enlarged to depict a portion of the dental arch;

FIG. 3A is a perspective view of an orthodontic appliance in the form of an attachment according to embodiments of the disclosure;

FIG. 3B is a perspective view of another orthodontic appliance in the form of an attachment according to embodiments of the disclosure;

FIG. 3C is a perspective view of another orthodontic appliance in the form of an attachment according to embodiments of the disclosure;

FIG. 4 is a perspective view of a fixture model including a mold body and apertures according to embodiments of the disclosure;

FIG. 5 is an enlarged, perspective view of the fixture model of FIG. 4;

FIG. 6 is a rear perspective view of an aperture of the fixture model of FIGS. 4 & 5;

FIG. 7 is a workflow for creating a virtual mockup to aid in the creation of the physical mockup of FIGS. 1 and 2;

FIG. 8 is a perspective view of a virtual orthodontic appliance in the form of an attachment according to embodiments of the disclosure;

FIG. 9 is a perspective view of a virtual mockup including appliances placed on the virtual teeth according to embodiments of the disclosure;

FIG. 10 is a perspective view of transfer tray created from a physical mockup of the present disclosure; and

FIG. 11 is a cross-sectional view of the transfer tray of FIG. 10.

While the above-identified figures set forth several embodiments of the disclosure, other embodiments are also contemplated, as noted in the description. In all cases, this disclosure presents the invention by way of representation and not limitation. It should be understood that numerous other modifications and embodiments can be devised by those skilled in the art, which fall within the scope and spirit of the principles of the invention.

### DETAILED DESCRIPTION OF THE ILLUSTRATIVE EMBODIMENTS

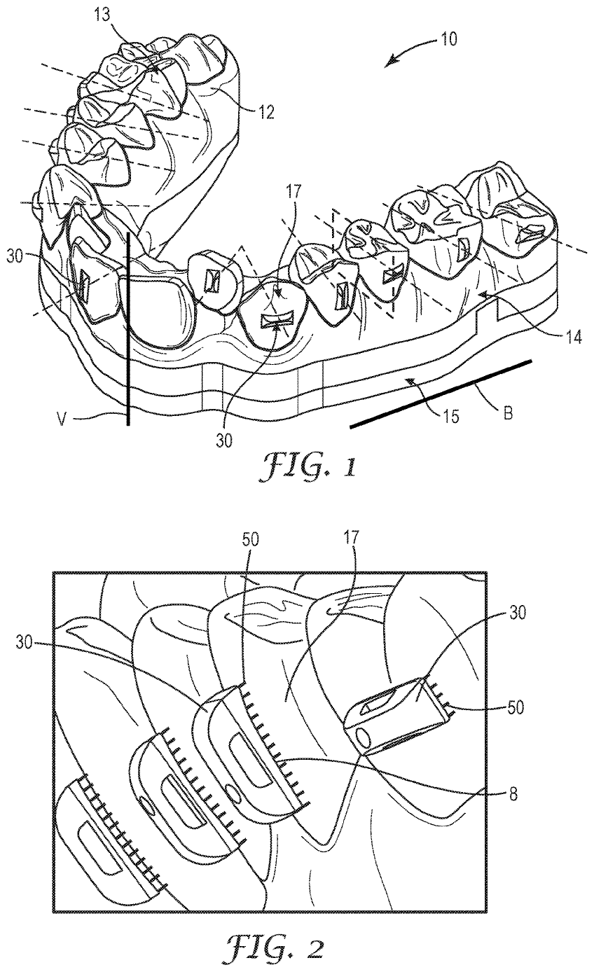

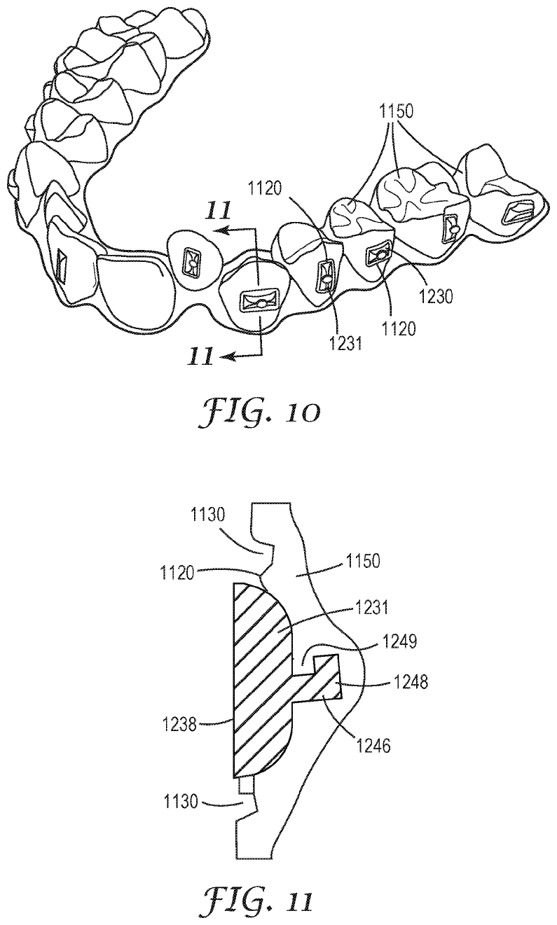

FIGS. 1 and 2 show a physical mockup 10 representing the positive shape of a patient's dental arch 12 including a plurality of teeth 13 and gingiva 14. The physical mockup 10 may be used for physically shaping a transfer apparatus (not shown in FIG. 1 or 2) for bonding orthodontic appliances at predetermined locations on a patient's teeth. The transfer apparatus forms a negative replica of at least part of the physical mockup 10. Such a transfer apparatus (see e.g., FIG. 10) may for example be obtained from taking an impression from the physical mockup 10, from overmolding the physical mockup 10 or from any other technique in which the positive physical model 10 is used for, preferably directly, shaping a negative replica.

The transfer apparatus so created from the mockups of the present disclosure may be used to bond orthodontic appliances at prescribed positions and orientations on a patient's dental arch. As used herein, “position” refers to the locating of the appliance at a particular point on the surface of a tooth and “orientation” is the location of appliance relative to an axis or plane of the mockup or the dental arch. An appliance can have a change in orientation that does not change its position on the surface of the tooth. For example, an appliance can be positioned at a particular point on the surface of a tooth and then can be oriented by rotating it, for example, about an axis perpendicular to the surface of the tooth.

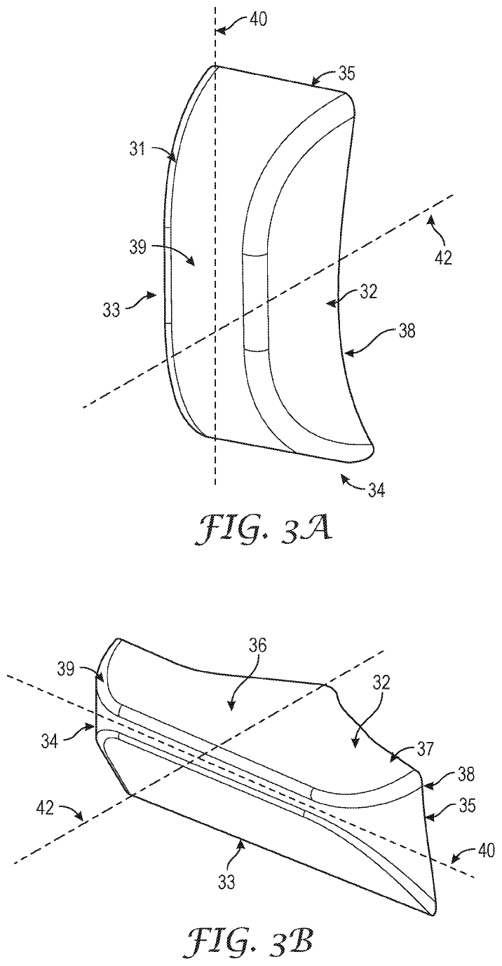

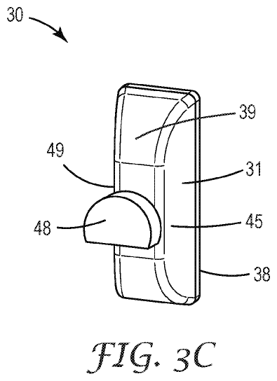

While the mockups of the present disclosure can be used to create transfer apparatuses for multiple orthodontic appliances (brackets, anchors, buttons, etc.), the appliances 30 depicted in FIG. 1 have the shape and function of orthodontic attachments for CTAs. As depicted in greater detail in FIGS. 3A and 3B, the appliance 30 includes an appliance body 31 (“body 31”) that is configured to be bonded to the teeth to improve force application by a CTA to achieve desired tooth movements. Body 31 may have any suitable shape, such as a custom-formed shape that is unique to a particular application, patient, tooth, and/or region of a tooth. Body 31 may be sized such that body 31 is difficult to manipulate, e.g., using a tool such as tweezers. For example, body 31 may have a maximum dimension of 30 millimeters (mm) or less and a minimum dimension of 0.25 mm or greater. For typical orthodontic attachments, the body 31 may have a maximum dimension of 10 mm or less.

As depicted in FIGS. 3A, 3B, and 3C, the body 31 has a generally rectangular shape and includes opposing long edges 32, 33. The long edges 32, 33 are joined by short edges 34, 35. Any one of edges 32, 33, 34, 35 may be concave, convex, linear, or combinations thereof. The long edges 32, 33 each can optionally include a concave middle section with generally linear sections proximate the short edges 34, 35. The short edges 34, 35 themselves are generally linear, though this is not required.

A bonding surface 38 of body 31 may be shaped to correspond to a contour of a portion of a tooth of a patient. In one or more embodiments, the bonding surface 38 of one or more appliances 30 can include any suitably shaped surface that is not necessarily customized to fit a particular surface of a tooth, i.e., a “generic” base. The bonding surface 38 may include compound curvature corresponding to the expected or average convex curvature of a particular tooth of the dental arch. Corresponding to the contour of the tooth may improve strength of an adhesive bond between body 31 and the tooth, reduce an amount of adhesive required for the bond, or both. For example, the bonding surface 38 can be shaped to bond at the facial axis of the clinical crown (“FACC”) of a particular tooth of a particular dental arch. The FACC is defined as the curved line formed by the intersection of the mid-sagittal plane and the facial surface of a given tooth. In some examples, bonding surface 38 may include etched, sandblasted, and/or embossed patterns intended to facilitate more secure bonding.

The bonding surface 38 can have a tooth facing surface contour that is customized to fit any suitable surface of a tooth. For example, in one or more embodiments, the bonding surface 38 has a tooth-facing surface contour that is customized to fit a labial surface of a given tooth. Having a customized bonding surface 38 can allow the appliance 30 to be configured with a lower profile for patient comfort. Any suitable technique or combination of techniques can be utilized to form customized bondable surfaces, e.g., the techniques described in U.S. Pat. No. 10,136,965 (Wiechmann, et al.), and U.S. Patent Publication No. 2005/0277084 (Cinader, Jr., et al.) and including, for example, the Boolean subtraction of a virtual tooth from a virtual appliance bonding surface in CAD or other software.

The body 31 may include any suitable shape that is configured to transfer a force from a CTA to the tooth, retain the CTA on the tooth, or both. For example, one or more portions of body 31 may be hemispherical, rectilinear, curvilinear, or irregular in shape. In some examples, any surface of the body 31 may include one or more surface features, including, but not limited to, one or more tapers, undercuts, overhangs, recesses, negative drafts, or other features configured to engage or otherwise interact with a CTA or a transfer tray. As illustrated in FIG. 3B, body 31 may define a beveled buccal/lingual facing surface 39. In some examples, a beveled body 31 may improve release of body 31 from a transfer tray after bonding to a tooth and/or improve transfer of force from a CTA to the tooth by concentrating contact of the CTA with body 31 at the apex of the bevel or provide a lead-in for engagement when there is a mismatch in position between a CTA and tooth.

The buccal-lingual facing surface 39 may include at least one retention feature to aid in one or more of removing the appliance 30 from the mockup 10 and aiding the arrangement of the appliance in a transfer apparatus. As depicted in FIG. 3C and FIG. 11 below, the retention features may include buccal-lingually extending features and occlusal-gingivally (or mesial-distally, depending on orientation) extending features. For instance, the retention feature 45 can include a stem 1246 (shown in FIG. 11 and not FIG. 3C) projecting out from the facing surface 39 and a cap 48 at the far end of the stem 1246. The cap 48 projects in a substantially orthogonal direction from the end of the stem 1246 and includes at least one dimension greater than the stem to create one or more undercuts 49 adjacent the end of the stem 1246. Transfer apparatus material (see FIG. 11) may at least partially fill the area between the undercut(s) 49 and the facing surface 39, which in certain embodiments can aid retention of the appliance in the apparatus and enhance removal of the appliance from mockup 10. The stem and/or cap may be frangible, similar to sprues 50 below, or may remain with appliance 30. The stem 1246 as a whole may be conical, frusto-conical, pyramidal, frusto-pyramidal, or any other appropriate shape. Likewise, the cap 48 may be triangular, rectangular, elliptical, circular, ovular, hemispherical, or any other appropriate shape.

The appliance 30 includes a long axis 40 (i.e., longitudinal axis), as well as a central axis 42 normal to the long axis 40 and extending through the both the bonding surface 38 and the facing surface 39. The axes 40, 42 extend through the approximate center of the appliance, which may be both the mesial-distal and occlusal-gingival center, though the precise identity will depend on appliance 30 orientation on the bonding surface. The long axis 40 extends between the short edges 34, 35. Both of the long axis 40 and central axis 42 can, in certain embodiments, be useful for locating the appliance 30 at the desired position and orientation on the tooth, as well as dictating certain aspects of the physical mockup 10, as further explored below.

Returning to FIGS. 1 and 2, the mockup 10 includes a support body (i.e., mold body) 15 extending below the gingiva 14 to provide stability for improved ease of mockup creation and subsequent transfer apparatus manufacturing. The bottom of the mold body is typically substantially planar, creating a base plane “B”. The mockup further includes a vertical axis “V” that is perpendicular to the occlusal plane of the dental arch, which can be determined using techniques known in the art and further described below. The vertical axis V can be normal to the base plane B in some locations along the arch 12, but this is not typical or necessary.

In the physical mockup 10 the patient's teeth 13 are represented in the malocclusion at the beginning of either treatment or a new stage of treatment. The exemplary mockup 10 shown in the drawings is representative of the patient's upper dental arch, although it should be understood the methods and systems of the present disclosure are equally suitable for the patient's lower dental arch. The entire, upper dental arch 12 is depicted in FIG. 1, while an enlarged portion of the arch is depicted in FIG. 2 for descriptive clarity. Alternatively, the physical mockup may include the entire dental arch (FIG. 1) or a lesser portion thereof (for example, an arch quadrant or a single tooth, not shown) depending on the number of appliances intended to be bonded to the teeth during a given bonding procedure.

The interior volume of the mockup 10 may be at least partially filled with material. In some embodiments, including those with apertures described below, it can be advantageous for the interior volume of mockup to be at least partially empty, allowing access to areas adjacent the tooth surfaces from the interior. In such embodiments, the interior may include support beams or other scaffolding to support the physical integrity of the mockup during creation of the mockup itself or the transfer apparatus. In other embodiments, the interior volume may unfilled, leaving the mockup essentially hollow.

While the mockup 10 as depicted includes representations of all tooth surfaces and adjacent gingiva, other embodiments may feature less fidelity to the patient's dental arch. For instance, a mockup 10 may include only a positive representation of occlusal and labial surfaces of the teeth, which may be viable for labial bonding of appliances. In such embodiments, the lingual surfaces may be omitted from the arch or may be generic and not representative of the patient's tooth surfaces. Typically, but not exclusively, a least the patient's occlusal surfaces are represented in the mockup to ensure adequate registration of the eventual transfer apparatus with the patient's actual dental arch. Any surface of the mockup may include indicia identifying the associated tooth, patient, or phase of treatment relevant to the appliance 30. The indicia may include text, symbols, coloring, or the like.

An orthodontic appliance 30 is fixed adjacent the bonding surface 17 (here labial tooth surface) of several teeth 13. Appliances 30 may be attached to all of the teeth 13 in the dental arch 12 or may be attached to only certain selected teeth as may be desired by the practitioner or otherwise prescribed according to an orthodontic treatment plan. As depicted in FIG. 1, each tooth 13 of the dental arch 12 receives an appliance 30 except an upper central and an upper lateral. Each appliance 30 on physical mockup 10 has been correctly positioned on the appliance bonding surface 17 of tooth 13 and oriented such that it can provide the desired force to the teeth of the patient when combined with another dental appliance (e.g., CTA) or appliance component (e.g., archwire or polymer band). Each appliance is connected to the bonding tooth surface 17 via one or more sprues 50.

The mockup 10 of this embodiment and the appliances of other embodiments, unless otherwise indicated, are described herein using a reference frame attached to a labial surface of a tooth on the upper jaw. Consequently, terms such as labial, lingual, mesial, distal, occlusal, and gingival used to describe the mockup 10 and appliance 30 are relative to the chosen reference frame. The embodiments, however, are not limited to the chosen reference frame and descriptive terms, as the appliance 30 may be used on other tooth surfaces and in other orientations within the oral cavity. For example, the mockup 10 may locate appliances proximate to the lingual surface of one or more teeth or locate appliances on both the lingual and labial tooth surfaces. Those of ordinary skill in the art will recognize that the descriptive terms used herein may not directly apply when there is a change in reference frame. Nevertheless, the embodiments are intended to be independent of absolute location and orientation within the oral cavity and the relative terms used to describe embodiments are merely to provide a clear description of the embodiments in the drawings. For the remainder of the application, the appliance bonding surface is inclusive of the labial, lingual, and occlusal (for e.g., bite stops) surfaces, but is depicted as the labial surface.

As depicted with additional clarity in FIG. 2, each appliance is coupled to a bonding tooth via a plurality of sprues. The sprues 50 can connect the tooth 17 to the appliance bonding base 38, as depicted, or may connect on other regions of the appliance body. The sprues 50 are frangible when bending, twisting, compression, or tension forces are applied, such as, for example, to sprues 50 via a tool or removal of the transfer apparatus from the mockup 10. In some examples, a size and/or a shape of sprues 50 may be selected to have a sufficient structural integrity to allow handling of mockup 10 while also breaking easily when desired. Sprues 50 may be broken by using a tool to bend twist or shear by pushing or pulling sprues 50. In the same or other implementations, the sprues 50 may include stress concentration features such as perforations, notches, scores, or otherwise weakened regions to aid in the separation of the sprues 50 from the appliance 30. In the same or other implementations, the sprues 50 can be made from a relatively rigid material that can be broken at or near the bonding base 38.

The cross-sectional shape (e.g., triangular, rectangular, elliptical, circular, ovular, etc.), of the sprues 50 can be uniform along a length of the body, or in other implementations the shape may vary. The sprues 50 as a whole may be conical, frusto-conical, pyramidal, frusto-pyramidal, or any other appropriate shape. To aid in the separation, each sprue 50 typically has a cross-sectional area between about 0.05 mm² and 0.75 mm², though the size of the area may change based on one or more of appliance body and geometry.

In some embodiments, one or more of the sprues 50 include a decreasing taper in a cross-sectional dimension as the appliance 30 is approached. Force may then be applied to the sprues 50 and the thicker portion adjacent the bonding tooth surface can resist the potential for the support to break during the formation of the transfer apparatus. Furthermore, a tapered sprue may negate the need for a cutting tool and separation of the appliance 30 from the dental arch 12 may only require the user to apply a compressive or tensile force on the thinner support end to initiate the break. Additionally, when the dental arch 12 and appliance 30 are separated, there may be reduced volume of the sprue 50 still attached to the appliance 30. In presently preferred implementations, the sprues 50 included a square, elliptical, or circular cross-sectional shape with a decreasing taper.

In some examples, after breaking sprues 50, a vestige or a nub may be left on or within the body 31. In some examples, the vestige or nub may be removed using any variety of automated cutting and/or polishing tools. In other examples, the vestige or nub may be removed using pressure and friction generated by operation of a hand tool (e.g., a dental probe). In yet other examples, the vestige or nub may remain if it does not interfere with appliance engagement or patient comfort. In certain embodiments, the vestige or nub, if sufficiently proximate the bonding surface 38, may enhance bonding to the tooth by providing more bonding surface area.

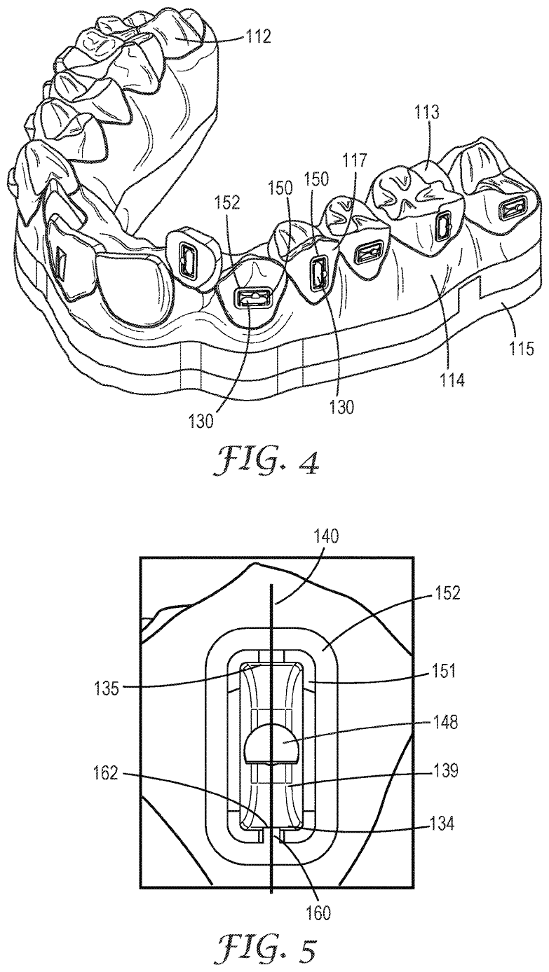

An alternative mockup 100 is depicted in FIGS. 4 and 5. Mockup 100 is similar in many respects to mockup 10, featuring a dental arch 112, gingiva 114, and support body 115, and considerations for physical mockup 10 apply mutatis mutandis to mockup 100 unless expressly noted. An orthodontic appliance 130 is fixed adjacent the bonding surface 117 (again labial tooth surface) of several teeth 113. The intended placement location for the appliance 130 can include an aperture 150 shaped to receive the appliance at the prescribed position and orientation. Rather than coupled directly to the tooth surface 117, however, one or more appliances 130 are held in the aperture 150 in the associated bonding tooth.

The location (i.e., position and orientation) of the aperture 150 on the tooth surface 117 corresponds to the location of the appliance 130 according to the treatment plan. The aperture 150 includes a geometry complemental to the appliance 130, with a volume large enough to accept at least a portion of the appliance 130 within the depth of the aperture 150. The mesial-distal and occlusal-gingival dimensions of the aperture 150 are accordingly, typically larger than the corresponding dimensions of the associated appliance. The depth need not be commensurate with the height of the appliance 130, as the appliance 130 is held in the aperture such that a least a portion of the body 131 projects outward (i.e., in a direction away from the interior of the mockup) from the opening 151.

The aperture 150, as depicted, is open to both the exterior and interior surfaces of the mockup 100. In other embodiments, an aperture 150 can instead be a recess that is closed on one end and terminating at a facial surface below the bonding surface. The aperture 150 can aid in both locating the appliance 130 on the mockup 100 and reducing or eliminating superfluous gaps between the appliance and tooth when the appliance is seated in the patient's mouth, leading to improved bonding to the tooth surface. An aperture 150 can also aid in positioning the bonding surface 38 nearer the tooth than the wall surfaces of a transfer apparatus, ensuring the transfer apparatus does not interfere with the appliance bonding at the bonding site. In the same or other embodiments, an aperture 150 can provide space to receive a compressible material from within the interior of the mockup 100 prior to forming the transfer apparatus, such that the compressible material can subsequently be fixed to the bonding surface 138.

The perimeter of the aperture 150 may include a frame 152 that projects outward from the tooth surface 117. The frame 152 may be continuous about the perimeter as depicted, or may be discontinuous (i.e., featuring two or more frame segments). The appliance 130 is held in the aperture 150 through one or more frangible sprues 160 extending from the frame 152. The frame 150 can be joined to the appliance 130 at various connection points 162 on the body 131. In presently preferred implementations, the connections 162 are spaced in the direction of the appliance facing surface 139 from an edge of the bonding surface 138, providing adequate clearance for the sprues 160 from the bonding tooth surface. The connections 162 are typically along a single edge of the appliance 130, which can aid in the separation of the appliance from the mockup 100 during formation of a transfer apparatus.

Generally, but not exclusively, an appliance 130 oriented on a bonding tooth with a long axis 140 within no greater than 35 degrees rotation from the vertical axis V (or the axis perpendicular to the base plane B) of the mockup 100 can be coupled to the frame via a sprue 160 with a connection 162 on a short edge 134, 135 at the gingival-most point on the body 131. An appliance 130 having a long axis 140 oriented within greater than 35 degrees to 90 degrees rotation from the vertical axis V (or the axis perpendicular to the base plane B) can be positioned with two or more sprues connecting to the one long edge 132, 133 of the body 131. An appliance 130 having a length along the long axis 140 greater than about 4 mm typically, but not exclusively, includes three sprues 160 with connections 162 along a long edge. It is contemplated, however, that more sprues may be arranged along one or more edges of the appliance (e.g., arranged radially about the appliance body 131). In some examples, it may be advantageous to use more than two sprues for a larger attachment body and/or to increase the robustness of the article during fabrication and handling, thereby preventing premature breakage, thus more than two connection points may be incorporated into any of the articles described above if desired.

As depicted, the sprues 160 are substantially coplanar with the frame 152. In other embodiments, the sprues 160 may project in a facial or lingual direction, leading to the appliance 130 being positioned above the bonding tooth surface 117 or deeper within the volume of the aperture 150. The projecting direction of the sprues 160 may be the same for each aperture 150 of each bonding tooth, or may vary depending upon a treatment plan across the various bonding teeth of the mockup 100. It may be desirable to hold the appliance 130 more remote from the patient tooth surface (i.e., a continuation of the model tooth surfaces surrounding the aperture 150) or with a greater portion of the body within the aperture. An offset between appliance and tooth surface may, for example, accommodate a bonding adhesive or ensure contact with the patient's tooth when the appliance is seated with a transfer apparatus.

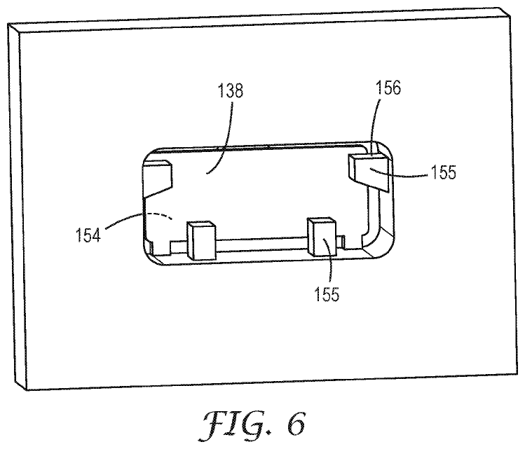

One or more of the apertures 150 feature one or more arresting ledges 155 projecting from an interior surface of the aperture 150 near the rear opening 154, with FIG. 6 providing a representative view of an aperture 150 looking outward from within the dental arch. The arresting ledge(s) 155 include stop surfaces 156 located in a lingual direction from the appliance bonding base 138. The stop surfaces 156 are initially not in contact with the appliance 130 or the bonding base 138. Instead, the ledges 155 aid in preventing the appliance 130 from receding into the mockup 100 when the sprues are fractured during formation of the transfer apparatus. In this way, the appliance 130 is essentially suspended above the arresting teeth 155 upon creation of the mockup.

The above depictions and discussions focus primarily on the bonding of a single appliance to a single tooth surface. It is contemplated that more than one appliance may be bonded to a tooth surface according to the concepts of the present disclosure, and/or that more than one tooth surface serves as a bonding surface. In the latter case, one or more appliances may be bonded, for example, to the lingual and labial surfaces of the requisite tooth. Other combinations and modifications are possible and within the scope of the present disclosure.

Any component of the physical mockup 10 may be manufactured by additive manufacturing. Accordingly, the position of the appliance 30 relative to the dental arch 12 can be determined by computer aid and manual assembly tolerances can be avoided. Examples of suitable additive manufacturing processes include solid freeform fabrication such as 3D printing processes, stereolithography methods, fused deposition modeling, laminated object manufacturing, laser engineered net shaping, selective laser sintering, shape deposition manufacturing, selective laser melting, and solid ground curing.

The physical mockup 10, and any or all components thereof, can be made from the full range of 3D printed materials, molded polymeric material or CAD/CAM shaped polymeric materials having certain desired strength, flexibility, translucency, or color. For example, the material can be polymeric material that may be transparent, translucent, or opaque. In some embodiments, clear or substantially transparent polymeric material that may include, for example, one or more of amorphous thermoplastic polymers, semi-crystalline thermoplastic polymers, transparent thermoplastic polymers, and thermoset polymers. Thermoplastics can be chosen from polycarbonate, thermoplastic polyurethane, acrylic, polysulfone, polyprolylene, polypropylene/ethylene copolymer, cyclic olefin polymer/copolymer, poly-4-methyl-1pentene or polyester/polycarbonate copolymer, styrenic polymeric materials, polyamide, polymethylpentene, polyetheretherketone and combinations thereof. In another embodiment, the body material may be chosen from clear or substantially transparent semi-crystalline thermoplastic, crystalline thermoplastics and composites, such as polyamide, polyethylene terephthalate. polybutylene terephthalate, polyester/polycarbonate copolymer, polyolefin, cyclic olefin polymer, styrenic copolymer, polyetherimide, polyetheretherketone, polyethersulfone, polytrimethylene terephthalate, and mixtures and combinations thereof. In some embodiments, the body material is a polymeric material chosen from polyethylene terephthalate, polyethylene terephthalate glycol, poly cyclohexylenedimethylene terephthalate glycol, and mixtures and combinations thereof. In additional embodiments thermoset polymers include acrylics, urethanes, esters, silicones, thiolenes, epoxies, olefin metathesis and combinations thereof.

In certain presently preferred circumstances, the mockup is integrally formed as a unitary component as part of an additive manufacturing process or injection molding process. The mockup of the present disclosure may be made of metal (such as alloys of stainless steel or other metallic materials), ceramic materials (including monocrystalline and polycrystalline light-transmitting ceramics) and polymeric materials (such as fiber-reinforced polycarbonate). Suitable ceramic materials are described, for example, in U.S. Pat. No. 6,648,638 (Castro et al.). Suitable materials for use in additive manufacturing may include, but are not limited to, materials described in International Publication Nos. WO 2020/104873 (Chakraborty et al.), WO 2019/048963 (Parkar et al.), WO 2018/231583 (Herrmann et al.), WO 2016/191534 (Mayr et al.), WO 2016/191162 (Mayr et al.), and WO 2014/078537 (Sun et al.). Other material iterations and combinations are also possible.

Under presently advantageous circumstances, the mockup may be formed from a curable composition primarily featured for creating certain dental crowns. The curable composition includes a resin matrix comprising: polymerizable (meth)acrylate(s) not comprising a urethane moiety, polymerizable urethane (meth)acrylate(s), filler including nanocluster(s), and an initiator system. Such compositions include a viscosity below 150 Pa*s at 23 °C and a shear rate of 1 s⁻¹ and do not include a softener in an amount of more than 5 wt. %. The composition, in greater detail, may comprise the polymerizable (meth)acrylate(s) not comprising a urethane moiety in an amount of 40 to 85 wt. %, polymerizable urethane (meth)acrylate(s) in an amount from 1 to 35 wt. %, nanocluster in an amount of 5 to 40 wt. %, fumed silica in an amount of 0.5 to 5 wt. %, photoinitiator in an amount of 0.01 to 3 wt. %, and organic dye in an amount of 0.001 to 0.5 wt. %.

Such curable compositions can be characterized by a combination of specific properties such as high mechanical strength, high fracture resistance and high aesthetics including stain resistance. The cured article has typically the following properties alone or in combination: 1) flexural strength: 50 to 200 MPa or 80 to 150 MPa determined according to ISO 4049:2009 using a test bar having the dimensions 6*4*25 mm, while 6 mm is the width of the test bar; 2) E-modulus 1,000 to 4,000 MPa determined according DIN EN 843-2:2007 using the flexural strength method, while calculation of the modulus is done in the range of 20% and 50% of maximum force of the samples; and 3) impact strength: 5 to 15 KJ/m2 determined according to DIN 53453:175-05. Further details regarding these compositions may found in European Patent No. 3638189 (Herrmann et al.). Other suitable compositions for additive manufacturing include, for example, a composition comprising a (meth)acrylate not comprising a urethane moiety, a urethane (meth)acrylate, photo-initiator, additives, discrete filler particles having an average particle size in the range of 10 to 40 nm and having been surface treated with a silane surface treating agent selected from a silane surface treating agent comprising a (meth)acrylate moiety, a silane surface treating agent not comprising a (meth)acrylate moiety, and a mixture of both, the discrete filler particles being present in an amount of 20 wt. % or more, the curable composition not comprising the following components alone or in combination: aggregates of nano-sized particles, agglomerates of nano-sized particles, fumed silica, each in an amount of 2 wt. % or more, wt. % with respect to the whole composition. The cured article has typically the following properties alone or in combination: 1) flexural strength: 50 to 200 MPa, determined according to ISO 4049(2019); 2) E-modulus: 1 to 4 GPa, determined according to DIN EN 843-2:2007. Further details on such compositions may be found, for example, in co-owned application Attorney Docket No. 84557EP002 entitled “Curable Composition for Producing Orthodontic Attachments”, filed Jul. 21, 2022.

Commercially available resins suitable for appliances also include those listed below in Table 1:

TABLE 1
Exemplary Suitable Resins for Additively
Manufacturing Appliances

| Product name | Manufacturer |
|---|---|
| VarseoSmile Temp | BEGO USA, Inc. (Lincoln, RI) |
| GC Temp PRINT (light) | GC America (Alsip, IL) |
| GC Temp PRINT | GC America |
| IMPRIMO LC Temp | Scheu Dental Group GmbH (Iserlohn, |
| | Germany) |
| IMPRIMO LC Temp lt. | ScheuDental |
| FREEPRINT temp UV | Detax GmbH (Ettlingen, Germany) |
| Temporary Crown&Bridge | SprintRay Inc. (Los Angeles, CA) |
| NextDent C&B MFH | NextDent B.V. (The Netherlands) |
| saremco print CROWNTEC | SAREMCO Dental AG. (Rebstein, |
| | Switzerland) |
| Optiprint temp | dentona AG (Dortmund, Germany) |
| Denture Teeth Resin | Formlabs (Somerville, MA) |
| VarseoSmile Crown plus | BEGO USA, Inc. |

The appliance and dental arch can be formed of the same material or can be formed of different materials through one or more manufacturing processes. For example, a photopolymerizable material used to form a mockup optionally includes a first composition and a second composition and making the mockup includes selectively curing the first composition to form the appliance 30 and selectively curing the second composition to form the dental arch and/or mold body. In some examples, the appliance may be formed of a material that has a higher ultimate strength than a material of which arch and mold body are formed.

In some examples, the methods of the present disclosure may include a three-dimensional (3D) printing step in the creation of the model dental arch 12 (including mold body), the appliance 30, the optional ledges 155 and frame 152, or any combination thereof. Three-dimensional printing may include, for example, forming the article from a plurality of layers of a photopolymerizable material described herein by selectively curing the photopolymerizable material in a layer-by-layer manner. In some examples, additive manufactured article may include a plurality of materials bonded to each other. The layers of the photopolymerizable material can be deposited according to an image of the three-dimensional article in a computer readable format. For example, the photopolymerizable material may be deposited according to preselected computer aided design (CAD) parameters (e.g., a data file). In some examples, the photopolymerizable material is cured using actinic radiation, such as UV radiation, e-beam radiation, visible radiation, or combinations thereof.

The foregoing techniques can be repeated a selected number of times to provide the 3D article. For example, in some cases, this process can be repeated “n” number of times. Further, it is to be understood that one or more steps of a method described herein, such as a step of selectively applying energy to a layer of photopolymerizable composition, can be carried out according to an image of the 3D article in a computer-readable format. Suitable printers include the VIPER, from 3D Systems, the D30II or D90, available from Rapid Shape, Heimsheim, Germany; and the MOONRAY, available from SprintRay, Los Angeles, California.

Other techniques for three-dimensional manufacturing may be suitably adapted to the techniques described herein. More generally, three-dimensional fabrication techniques continue to become available and may be adapted to use with photopolymerizable compositions described herein, provided they offer compatible fabrication viscosities and resolutions for the specified article properties, for instance continuous additive manufacturing in which a build plate is (essentially) continuously moved through a vat of photopolymerizable material. In certain examples, an apparatus adapted to be used in a continuous mode may be employed, such as an apparatus commercially available from Carbon 3D, Inc. (Redwood City, CA), for instance as described in U.S. Pat. Nos. 9,205,601 and 9,360,757 (both to DeSimone et al.). For example, in any method described above, selective curing of a photopolymerizable material includes continuous photopolymerization of at least one of the first portion of the article or the second portion of the article. Further details of methods for additive manufacturing may be found in International Publication No. 2021/130624 (Cinader et al.), entitled Preformed Orthodontic Attachments.

### Designing and Creating the Physical Mockup

The manufacturing of the physical mockup is typically based on a virtual mockup prepared in a computer system. Such a virtual mockup preferably corresponds to a mathematical representation of a three-dimensional shape which can be processed by a computer, for example by a CAD system. Further the virtual mockup is preferably available in the form of computer data which can be used to control an additive manufacturing machine for manufacturing the physical mockup as defined by the virtual mockup. The virtual mockup may be designed or generated from superimposing or merging a virtual dental arch of a patient with a set of virtual appliances as further described below.

The functions or algorithms described herein may be implemented in software in one embodiment. The software may consist of computer executable instructions stored on computer readable media or computer readable storage device such as one or more non-transitory memories or other type of hardware-based storage devices, either local or networked. Further, such functions correspond to modules, which may be software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system, turning such computer system into a specifically programmed machine. The term “processor,” as used herein may refer to any of the foregoing structure or any other structure suitable for implementation of the techniques described herein. In addition, in some aspects, the functionality described herein may be provided within dedicated software modules or hardware modules configured for performing the techniques of this disclosure. Even if implemented in software, the techniques may use hardware such as a processor to execute the software, and a memory to store the software. In any such cases, the computers described herein may define a specific machine that is capable of executing the specific functions described herein. Also, the techniques could be fully implemented in one or more circuits or logic elements, which could also be considered a processor.

Often, computer readable media are provided as part of a computing device. The computing device may have one or more processors, volatile memory (RAM), a device for reading machine-readable media, and input/output devices, such as a display, a keyboard, and a pointing device. Further, a computing device may also include other software, firmware, or combinations thereof, such as an operating system and other application software. A computing device may be, for example, a workstation, a laptop, a tablet, a smart phone, a personal digital assistant (PDA), a server, a mainframe or any other general-purpose or application-specific computing device. A computing device may read executable software instructions from a computer-readable medium (such as a hard drive, a CD-ROM, or a computer memory), or may receive instructions from another source logically connected to computer, such as another networked computer. Data can be communicated directly to an application, e.g., on a mobile device and/or directly to a cloud platform system via cellular connection, a Wi-Fi router or a hub.

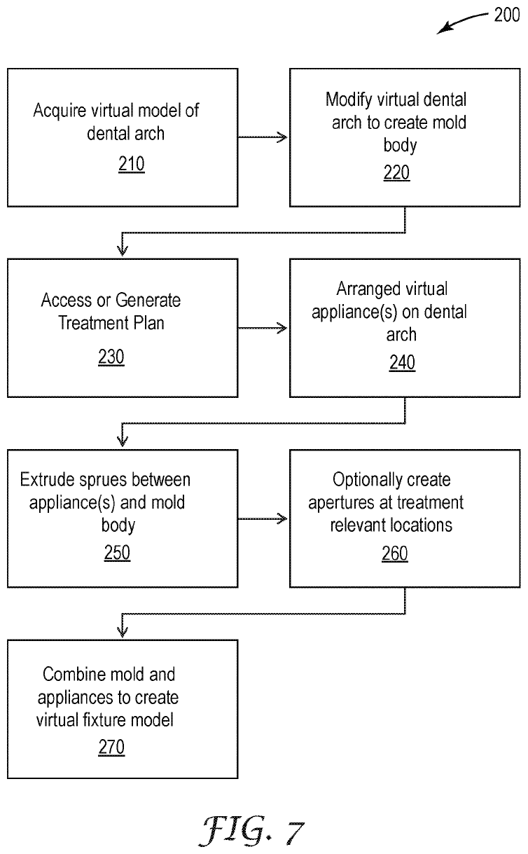

In general, and as depicted in FIG. 7, the process 200 for designing a mockup begins with the acquisition of a virtual model of a patient's dental arch (step 210). The virtual dental arch model may be modified to create a solid virtual mold body (step 220). A plan for treatment may be accessed or generated based at least in part on the virtual model of the patient's dental arch (step 230). Virtual appliances are obtained and arranged on the teeth at treatment relevant locations, according to the treatment plan (step 240). One or more frangible sprues are then extruded between the body of each appliance and the dental arch. (Step 250). Optionally, an aperture is created at the treatment relevant locations for receipt of a portion of an appliance (Step 260). The aperture may optionally include one or more stop features offset from the base of the appliance in a facial-lingual direction. The dental arch and appliances are combined to create a virtual fixture model for subsequent fabrication (step 270). Individual aspects of the process are discussed in further detail below.

The process 200 can be used to generate mockups at any stage of the treatment. In one example, a mockup may be generated for each phase of the treatment (and attendant placement of appliances) at the commencement of treatment. In other examples, the creation of mockups may be phased to allow for confirmation of the patient's treatment progress, such that a new or updated model of the patient's dentition is acquired before beginning work on a subsequent mockup. At various stages, the process for generating the original treatment plan can include interaction with the treating practitioner responsible for the treatment of the patient. Practitioner interaction can be implemented using the network platform and any connected participant.

As an initial step in creating a virtual model of the patient's dental arch, a mold or a scan of patient's teeth (and potentially mouth tissue) is acquired (Step 210). This generally involves creating a representation of the patient's teeth and gums, and may involve taking wax bites, using impression materials, casting, direct contact scanning, x-ray imaging, tomographic imaging, sonographic imaging, and other techniques for obtaining information about the position and structure of the teeth, jaws, gums and other orthodontically relevant tissue. A digital data set can be derived from this data that represents a current arrangement of the patient's teeth and other tissues. A virtual model of the dentition may then be re-constructed based on the digital data.

One increasingly common technique for acquiring at least a portion of the initial arrangement (or any subsequent arrangement) is digital scanning. A virtual dental model representing the patient's dental structure can be captured using a digital intraoral scan or by digitally scanning an impression or other physical dental model. Scanning devices which allow for providing a virtual dental arch in digital data form are intra-oral scanners or intra-oral contact probes, such as the True Definition™ Scanner, available from Midmark or the TRIOS scanner available from 3Shape A/S. As another option, the digital data file may be obtained by scanning an impression of the patient's teeth. As another option, the digital data may be obtained by scanning a physical model of the patient's teeth. The model used for scanning may be made by pouring a casting material (such as plaster of Paris or epoxy resin) into an impression of the patient's teeth and allowing the casting material to cure. Any suitable scanning technique may be used for scanning the model, such as X-ray, laser, computed tomography (CT), and magnetic resonance imaging.

The digital data may be “cleansed” by removing any data points that represent clear error. For example, files in STL format representing a tooth surface that include a data point significantly outside the normal expected geometrical relationship of adjacent data points could be fixed by STL-handling software to remove the erroneous data point. In addition, tooth data points that are missing could be added by STL-handling software to create realistic, smoothly curved tooth shapes. Alternatively, or in addition to, the data cleansing may be carried out on the data file before conversion of the data to an STL file. As an additional option, data may also be obtained of hidden features of the patient, such as the roots of the patient's teeth, the interproximal regions, and the jaw structure. For example, CT scanning techniques may be used to obtain data representative of the patient's entire tooth structure including the roots. The data obtained by CT scanning may then be “stitched together” with other data obtained by scanning the crowns of the patient's teeth with another scanning technique to provide a more comprehensive virtual representation.

Dentition surfaces may be segmented to produce one or more discrete, movable 3D tooth object models representing individual teeth. The tooth models may also be separated from the gingiva into separate objects. Segmentation allows a user to characterize and manipulate the teeth arrangement as a set of individual objects. Advantageously, the computer may derive diagnostic information such as arch length, bite setting, interstitial spacing between adjacent teeth, and American Board of Orthodontics (ABO) objective grading from these models.

A tooth coordinate system, defined by coordinate axes, can be defined for each discrete tooth surface in the virtual dental arch. The coordinate system may include a mesial-distal axis, a buccolabial-lingual axis, and an occlusal gingival axis for each tooth, with each axis computed as perpendicular to the other two axes. The coordinate system may be defined using computed or selected landmarks. Alternatively, the coordinate system may be created by defining a point on a virtual tooth, receiving axis input data that defines first and second axes associated with the virtual tooth, computing a substantially normal vector for a portion of the tooth surface surrounding the point, and computing the tooth coordinate system based on the axis input and the computed vector, Such methods, and well as other exemplary methods for creating tooth coordinate systems, are exemplified in U.S. Pat. No. 9,622,835 (Raby et al.). The tooth coordinate system allows for various modifications to one or more virtual teeth associated with the coordinate system. Aspects that may be adjusted or modified for each tooth include torque, tip, 1^{st} order rotation, mesial-distal movement (with or without interproximal reduction (IPR)), occlusal-gingival translation, and buccolabial-lingual translation. Each of these aspects relate to movement in one of the six degrees of freedom defined by the coordinate axes of the respective tooth surface. Such modification also includes the positioning and/or attachment of a virtual analog to a tooth.

One or both of the occlusal and midsagittal planes of the dentition may be specified for the virtual model. The occlusal plane is an imaginary surface that passes through the occlusion of the teeth and is generally approximated by a plane. The midsagittal plane is an imaginary plane passing longitudinally through the middle of the dental arch, dividing it into left and right halves. An initial approximation of the occlusal plane may be based on the shapes or coordinate systems of some or all of the tooth surfaces belonging to an individual arch of the dentition. For example, the occlusal plane may be defined by identifying three points that tangentially contact a plane superimposed on the dentition. For a given dental arch, the three points generally include at least one contact point from a left molar, one contact point from a right molar, and one contact point from a central or lateral tooth. In another embodiment, the occlusal plane is defined as a best-fit plane to the points representing the origins of the tooth coordinate systems, as previously defined. In effect, this plane represents the average of these origins, which are generally positioned at the incisal edges, single cusp tips, or buccal cusp tips of the teeth. The occlusal plane may also be used to calculate and define the vertical axis of the model. The vertical axis resides in a plane perpendicular to occlusal plane and can be used to gauge the orientation of appliances on the tooth and control the orientation of the crane bodies and alignment pins.

Similarly, the midsagittal plane may be derived based on the shape of the archform according to the coordinate systems of the tooth surfaces of the dentition. Manual adjustments of the occlusal and midsagittal planes to the locations and/or orientations relative to the dentition surface can be made as desired. Area below the teeth and/or gingiva may be extruded to a planar surface to create the virtual support body (step 220). Typically, the extrusion is performed along a path generally normal to the occlusal plane to a common plane spaced about 2 to about 30 mm from the either the occlusal plane or the gingival most point on the model before creation of the support body, as desired. The creation of the support body may be accomplished before or after the virtual appliances have been placed on the arch.

The method then proceeds to setting up a treatment plan for modifying the dental arch (step 230). The treatment plan will be used to specify the dimensions, shapes, identity, and location of the appliances. The steps of the process for generating a treatment plan can be implemented as computer program modules for execution on one or more computer systems. Modeling software can provide a user interface that allows for manipulating digital representations of the teeth in 3D space relative to the digital representation of the dental arch of the patient. The treating professional generates treatment information, such as by selecting indications of the final positions of individual teeth of the patient, duration of a respective stage of treatment, or number of treatment stages, the direction or magnitude of forces on the teeth of the patient during a stage of treatment, or the like. Systems and methods for generating an orthodontic treatment plan can be found, for example, in U.S. Pat. Nos. U.S. Pat. No. 7,435,083 (Chisti et al.), U.S. Pat. No. 7,134,874 (Chisti et al.), U.S. Patent Publication Nos. 2009/0286196 (Wen et al.); 2010/0260405 (Cinader), U.S. Pat. No. 9,259,295 (Christoff et al.) and International Publication No. WO2021/245480 and WO2021/245484 (Cunliffe et al.). Further details on software and processes that may be used to derive a target dental arrangement are disclosed, e.g., in U.S. Pat. No. 6,739,870 (Lai et al.), U.S. Pat. Nos. 8,194,067; 7,291,011; 7,354,268; 7,869,983 and 7,726,968 (Raby et al.),

The treatment planning step (step 230) typically includes receiving information regarding the orthodontic condition of a patient and/or practitioner preferences for treatment and subsequently generating an original treatment plan for repositioning the patient's teeth. This original treatment plan may represent the beginning of orthodontic treatment or may represent a new phase of treatment commenced after the patient has undergone some orthodontic or dental treatment. The treatment plan typically includes one or more phases of treatment depending on the desired treatment modality; with CTAs, the treatment plan will include multiple phases of treatment, each corresponding to an arrangement of teeth. For traditional braces or other wire driven appliance systems, the treatment plan may include a single phase, with a single target arrangement. The treatment plan is typically presented to a practitioner for modification and/or approval, though this is not strictly necessary. Appliances can be generated or selected based on the approved treatment plan, which will be provided to the practitioner and ultimately administered to the patient.

The treatment plan may be stored with other patient information in a patient dental health record (DHR). The DHR may be filled in via information from the patient and/or from treating professionals involved in the patient's care. For example, the DHR can include, but is not limited to including, patient medical information items including x-rays, 3D models of a dental patient's dentition, and/or pictures of the patient's smile. The DHR may also include other medical information, including current and past pharmaceutical prescriptions, health history, genomic information, etc. For patient identifying information, the DHR may include patient name, address, contact information (e.g., telephone number, fax number, electronic mail address), date of birth, gender, and/or dental insurance, among others. The DHR can also include personal treatment goals of the patient (e.g., gap closure, restoration, whitening). At each stage of treatment, the DHR may be updated to reflect treatment progress and include new 3D models of the patient's then-current dentition to aid in diagnosis and further treatment planning.

Desired final positions of the teeth, or tooth positions that are desired and/or intended end result of orthodontic treatment, can be received, e.g., from a treating professional in the form of a descriptive prescription, can be calculated using basic orthodontic prescriptions, or can be extrapolated computationally from a clinical prescription. With a specification of the desired final positions of the teeth and a digital representation of the teeth themselves, the final position and surface geometry of each tooth can be specified to form a complete model of the teeth at the desired end of treatment or treatment stage. The result of this step is a set of digital data structures that represents a desired and/or orthodontically correct repositioning of the modeled teeth relative to presumed-stable tissue. The teeth and surrounding tissue can both be represented as digital data.

Having both a beginning position and a final target position for each tooth, the process can next define a treatment path or tooth path for the motion of each tooth. This can include defining a plurality of planned successive tooth arrangements for moving teeth along a treatment path from an initial arrangement to a selected final arrangement. In one embodiment, the tooth paths are optimized in the aggregate so that the teeth are moved in the most efficient and clinically acceptable fashion to bring the teeth from their initial positions to their desired final positions. A movement pathway for each tooth between a beginning position and a desired final position may be calculated based on a number of parameters, including the total distance of tooth movement, the difficulty in moving the teeth (e.g., based on the surrounding structures, the types and locations of teeth being moved, etc.) and other patient-specific or practitioner-specific data that may be provided. Based on this sort of information, a user or a computer program may generate an appropriate number of intermediary steps (corresponding to a number of treatment steps). In some variations, the user may specify a number of steps, and the software can map different appliance configurations accordingly.

If the movement path requires that the teeth move more than a predetermined amount (e.g., 0.3 mm or less in X, Y, or Z translation), then the movement path may be divided up into multiple steps, where each step corresponds to a separate target arrangement. The predetermined amount is generally the amount that an appliance or appliance configuration can move a tooth in a particular direction in the time required for each treatment step. Each appliance configuration corresponds to a planned successive arrangement of the teeth and represents a step along the treatment path for the patient. For example, the steps can be defined and calculated so that each discrete position can follow by straight-line tooth movement or simple rotation from the tooth positions achieved by the preceding discrete step and so that the amount of repositioning required at each step involves an orthodontically optimal amount of force on the patient's dentition. The treatment plan can include a plurality of phases (1 through n) where at time=0, the initial treatment plan begins.

The user/treating professional may be offered several candidate treatment plans for selection as the original treatment plan. The candidate treatment plans can include simulations of treatment using only photographs supplied by the patient, or based on more comprehensive dental imaging (e.g., x-rays, digital scan, etc.) Candidate treatment plans may be generated using a rule-based approach, an optimization-based approach, a machine learning-based approach, or specific preferences (either patient or practitioner) as outlined in WO2021/245484 (Cunliffe et al.).

If the user or other professional is not entirely satisfied with the final predicted positions of the teeth, new final positions of the virtual teeth may be computed and displayed based on revised positions of either the virtual appliances or the virtual teeth. These steps can be repeated as many times as desired until all parties are satisfied. Data representing the selected positions of the teeth, along with identification data for each appliance (such as appliance type and bonding location) tooth identification data (such as tooth type and location in the oral cavity) and patient data (such as name and birth date, or a patient identification number) can be recorded in the DHR for further processing.

The methods of creating a mockup next proceeds to the step of obtaining and locating the virtual appliances relative to the virtual dental arch according to the desired treatment plan(s) (step 240). Though discussion proceeds on the basis of the virtual appliance being a virtual attachment or virtual bracket, one skilled in the art will understand that other virtual appliances suitable for bonding to the surfaces of the teeth (e.g., tubes, buttons, cleats, sheaths, bite ramps, bite blocks, etc.) may be accessed and coupled to the virtual dental arch. In an exemplary implementation, the virtual appliance is obtained based on a physical appliance standardized by prescription and available “off-the-shelf”. The person skilled in the art will however recognize that the present methods and systems may likewise be used in combination with appliances that may be customized for each tooth of each patient, or a combination of custom and standard appliances. In one implementation, virtual appliances can be selected from a library of pre-existing appliance constructions. Such fully-constructed appliances can be stored and accessible as CAD or STL (Standard Tessellation Language) files, for example. Appliances may be stored as rendered in an accessible library or generated subsequent to retrieval based on an intended location of the appliance on the dental arch. The virtual appliance may be placed on the virtual arch unmodified (i.e., that has not undergone any other shape adjustments) or may be modified after such placement.

The desired dimensions, shapes, and locations for the appliance on the model can be determined in any of a number of ways. Different considerations may influence the dimensions, shapes, and locations for orthodontic attachments compared to orthodontic brackets or other bonded appliances. For example, the final positions of individual teeth of the patient, duration of a respective stage of treatment, or number of treatment stages may affect the direction or magnitude of forces on the teeth of the patient at each stage of treatment. In some examples, orthodontic attachments may be used during at least one, but fewer than all stages of treatment. In some examples, the movements to be achieved, the forces applied, and the engagement of each tooth by each CTA may be determined by selecting the dimensions, shapes, and positions of an orthodontic attachment based on the treatment plan. Such analysis can be accomplished one or more times for a treatment plan. For example, it would be possible to have different attachments for each stage or possibly more, if desired. However, in many instances the attachment type, position, and/or orientation may be changed a few times during the treatment plan.

As another example, the attachments may be shaped and positioned to reduce intrusion of the tongue and/or the inside of the cheeks, particularly when a CTA is not in the mouth covering the attachments. The attachments also may be shaped and positioned to facilitate removal of the CTA from the teeth by enabling specific directional disengagement of the CTA with the attachments, e.g., which do not compromise the effectiveness of the treatment or retention of the CTA on the teeth. The attachments also may be shaped and positioned to, along with corresponding shells or aperture in the CTA, reduce visibility of the attachments when the CTA is worn by the patient. Through use of virtual modeling, attachments can be virtually tested and the best attachment type, shape, position, and/or orientation can be selected. From such analysis, different physical dental attachment placement apparatuses can be created from the virtual dental attachment placement apparatus data that would be utilized to create the attachments needed for the different stages.

In embodiments where the appliance is an orthodontic bracket, the virtual brackets can be connected to a virtual archwire, and the final positions of the teeth may be computed based on the positions of the brackets and the selected archwire. Assuming the final positions meet with approval, the virtual appliances may be placed at locations corresponding to the virtual brackets. As an alternative to moving appliances, a user may instead define the desired positions of teeth as described above, and the computer may include programming instructions to determine the suitable locations to place the appliances in order to move the teeth to those desired positions. Examples of virtual orthodontic treatment in this manner are disclosed in issued U.S. Pat. No. 6,739,869 (Kopelman et al) and U.S. Pat. No. 7,354,268 (Raby et al.).

As another option, orthodontic appliances may be placed on the virtual arch model based on standards or guidelines from an orthodontic treatment philosophy, such as for example that of Drs. MacLaughlin, Bennett, and Trevisi taught in textbook “Systemized Orthodontic Treatment Mechanics” 1st Edition by Richard P. Mclaughlin BS DDS, John C. Bennett FDS RCS, and Hugo Trevisi DDS. These standards or guidelines for appliance placement may be specific to each tooth in the model, and can call out the position of certain features (an occlusal-gingival height of an archwire slot, for example) with respect to the clinical crown of each tooth. The orthodontic appliances can also be placed in accordance with particular instructions provided by the treating professional. Again, these proposed orthodontic appliance locations are optionally based upon an orthodontic treatment philosophy or other known standards or guidelines in the art. Examples of automatically placing virtual brackets on teeth are described in U.S. Pat. No. 7,210,929 (Raby et al.), U.S. Pat. No. 8,517,727 (Raby et al.) and U.S. Pat. No. 7,940,258 (Stark et al.), all of which are hereby incorporated by reference.

The virtual appliances, whether created by the user or accessed from a virtual library, may be modified according to the treatment plan. In one embodiment, a modification step comprises increasing a three-dimensional volume represented by the virtual appliance by selectively modifying only a portion of the appliance. For example, the modification step may comprise a flattening or reduction of an indentation present in the appliance shape. The modification step may further comprise at least adding a virtual structure to the appliance shape, such as a connection points as described below. Undercuts may be minimized or removed. Further the modification step may comprise optionally reducing the three-dimensional volume by selectively modifying another portion of the appliance. The person skilled in the art will recognize various possibilities for modifying a shape, for example by change of an existing shape, adding or removing a shape, virtually copying, cutting, extending, reducing or another suitable technique. The skilled person will further be able to create a set of virtual appliances according to the treatment plan in any suitable manner.

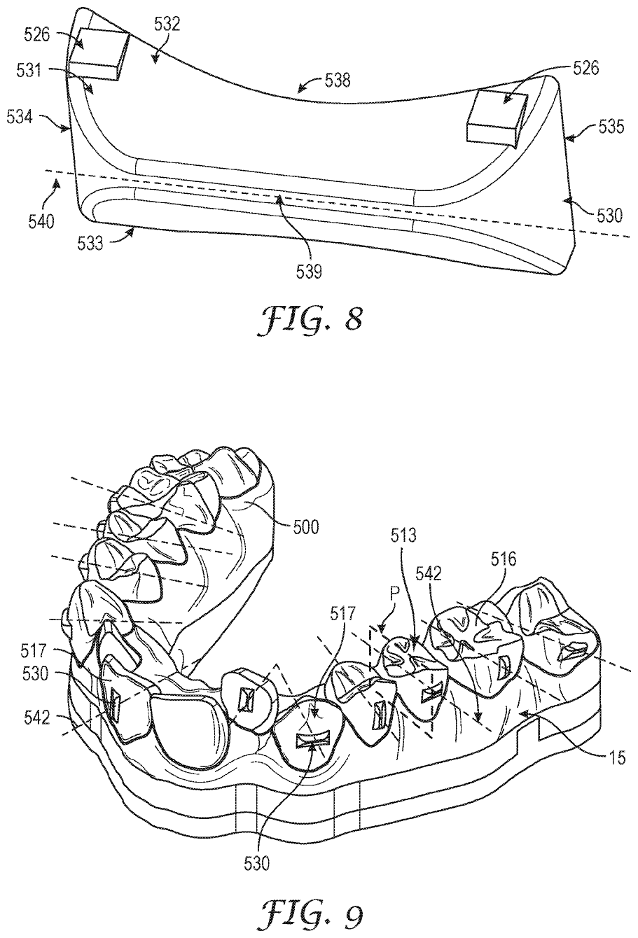

Connection points on the body of the virtual appliance for an eventual sprue can be created on the appliance before or after placement. In some implementations, the connection points are stored with the virtual appliance in the library. In other implementations, the connection points may be added during modification of the appliance or after the appliance has been positioned and oriented according to the treatment plan. FIG. 8 depicts a virtual appliance 530 with connection points 526 defined along a long edge 532. Virtual appliance 530 is similar in all respects to physical appliance 30. In presently preferred implementations, the connections 526 are spaced in the direction of the facing surface 539 from an edge of the bonding surface 538, providing adequate clearance for the sprues (not shown in FIG. 11) from the bonding tooth surface. The number and location of connection points typically follows the same considerations for sprues and can be dictated by at least one of (a) the orientation of the long axis of the appliance relative to an axis perpendicular to the base plane B; (b) the orientation of the long axis relative to vertical axis V; and (c) the dimensions of the appliance 30, all according to the treatment plan. The connection points 526 have the cross-sectional shape (here, rectangular) generally matching the preferred cross-sectional shape of the eventual coupling arm; this allows the coupling arm to be extruded directly from the body 531 as further explored below.

Turning to FIG. 9, a virtual mold body 500 is depicted with virtual appliances 530 (here having all features of attachments 30) dimensioned, shaped, and located according to the treatment plan on labial tooth surfaces 517 of associated teeth 513. The central axis 542 of each appliance 530 is generally parallel to the base plane B. A vertical plane P for each appliance 530 may be defined by the central axis 542, the base plane B, and optionally an occlusal surface of the associated tooth 513 directly occlusal to the central axis. As described above, the base plane B may be parallel to the occlusal plane, but this is not necessary.

At any point in the process after an appliance location has been satisfactorily confirmed, the shape of the appliance perimeter may be used to create an aperture in the bonding surface 517. For instance, the virtual attachment model can be modified according to the techniques above to have a uniform cross-sectional shape matching the perimeter of the bonding surface (e.g., the appliance base). This virtual appliance analog may be extruded in dimensions parallel to the central axis with an added offset (e.g., 200 microns) equivalent to the desired depth of the aperture and the clearance between the appliance and the frame perimeter. The virtual analog can then be Boolean subtracted from the virtual tooth surface, leaving an aperture having a shape matching the perimeter shape of the appliance bonding surface and clearance matching the selected offset. Other methods for creating an aperture having the shape of the appliance bonding surface and, optionally, a frame surrounding that aperture will be apparent to the skilled artisan.

Each sprue may be extruded between the appliance and the bonding tooth surface or frame. The sprues generally retain the cross-sectional shape of connection points 526, if used, and may include a taper, each as noted above. Also as noted above, sprues may be linear, arcuate along a single radius of curvature, include compound curvature, or include combinations of the same. Once each appliance 530 is attached via the requisite number of sprues to the associated bonding tooth, a complete virtual mockup is available for further manufacturing.

With a complete virtual mockup in place, the method proceeds to create an object model exportable for subsequent manufacturing, i.e., a fixture model comprising the combined appliances and dental arch. As an alternative, the components of the virtual mockup may be exported and fabricated separately, with the creation of the complete physical mockup 10 requiring the placement of each appliance on the dental arch model. The fixture model can be provided by combining the virtual constituent elements, for example being merged or superimposed by computer aid. The virtual fixture model can be maintained in the form of a computer processable three-dimensional data file, may be transmitted to a fabrication machine which manufactures a physical representation thereof.

In some examples, the fabrication of the fixture model from the virtual mockup may include a 3D printing process. In presently preferred implementations, the fixture model including appliances is created through 3D printing, with dental arch model and the appliances created through from same material. Suitable materials for each are described above.

Three-dimensional printing may include, for example, forming the fixture model from a plurality of layers of a photopolymerizable material described herein by selectively curing the photopolymerizable material in a layer-by-layer manner. In some examples, an additive manufactured article may include a plurality of materials bonded to each other. The layers of the photopolymerizable material can be deposited according to an image of the three-dimensional article in a computer readable format. For example, the photopolymerizable material may be deposited according to preselected computer aided design (CAD) parameters (e.g., a data file). In some examples, the photopolymerizable material is cured using actinic radiation, such as UV radiation, e-beam radiation, visible radiation, or combinations thereof.

Additionally, it is to be understood that methods of manufacturing a 3D article described herein can include stereolithography or vat polymerization. For example, the methods of the present disclosure may include retaining a photopolymerizable composition described herein in a fluid state in a container and selectively applying energy to the photopolymerizable composition in the container to solidify at least a portion of a fluid layer of the photopolymerizable composition, thereby forming a hardened layer that defines a cross-section of the 3D article. The methods also may include raising or lowering the hardened layer of photopolymerizable composition to provide a new or second fluid layer of unhardened photopolymerizable composition at the surface of the fluid in the container, followed by again selectively applying energy to the photopolymerizable composition in the container to solidify at least a portion of the new or second fluid layer of the photopolymerizable composition to form a second solidified layer that defines a second cross-section of the 3D article. Further, the first and second cross-sections of the 3D article can be bonded or adhered to one another in the z-direction (or build direction corresponding to the direction of raising or lowering recited above) by the application of the energy for solidifying the photopolymerizable composition. Moreover, selectively applying energy to the photopolymerizable composition in the container can include applying actinic radiation, such as UV radiation, visible radiation, or e-beam radiation, having a sufficient energy to cure the photopolymerizable composition. The methods of creating the physical mockup also may include planarizing a new layer of fluid photopolymerizable composition provided by raising or lowering an elevator platform. Planarization can be carried out, for example, by utilizing a wiper or roller or a recoater. Planarization may correct the thickness of one or more layers prior to curing the material by evening the dispensed material to remove excess material and create a uniformly smooth exposed or flat up-facing surface on the support platform of the printer.

The foregoing techniques can be repeated a selected number of times to provide the 3D article. For example, in some cases, this process can be repeated “n” number of times. Further, it is to be understood that one or more steps of a method described herein, such as a step of selectively applying energy to a layer of photopolymerizable composition, can be carried out according to an image of the 3D article in a computer-readable format. Suitable printers include the Viper Pro SLA, available from 3D Systems, Rock Hill, South Carolina; the Asiga PICO PLUS 39, available from Asiga USA, Anaheim Hills, California; the D30 II, available from Rapid Shape, Heimsheim, Germany; and the Moonray, available from SprintRay, Los Angeles, California.

A related technology, vat polymerization with Digital Light Processing (“DLP”), also employs a container of curable polymer (e.g., photopolymerizable composition). However, in a DLP based system, a two-dimensional cross section is projected onto the curable material to cure the desired section of an entire plane transverse to the projected beam at one time. All such curable polymer systems as may be adapted to use with the photopolymerizable compositions described herein are intended to fall within the scope of the term “vat polymerization system” as used herein.

One or both of the appliances and dental arch model may be created on a build platform of any suitable shape. For example, the build platform may include a substantially planar plate, one or more elongate runners, or the like. Build platforms may also include frangible sprues which support mockup components fabricated on the build platform. Build platform sprues, like those connecting the appliance to the bonding tooth, are configured to break in response to a bending, twisting, compression, or tension. The build platform may include indicia identifying the physical mockup components thereon. The indicia may include text, symbols, coloring, or the like. For example, build the platform may be formed by the additive manufacturing techniques described herein to include text embossed on a surface of the build platform to indicate the patient or phase of treatment.

Other techniques for three-dimensional manufacturing, including but not limited to fused deposition modeling, selective laser sintering, and inkjet printing, may be suitably adapted to the methods described herein. More generally, three-dimensional fabrication techniques continue to become available and may be adapted to use with photopolymerizable compositions described herein, provided they offer compatible fabrication viscosities and resolutions for the specified article properties, for instance continuous additive manufacturing in which a build plate is (essentially) continuously moved through a vat of photopolymerizable material. In certain examples, an apparatus adapted to be used in a continuous mode may be employed, such as an apparatus commercially available from Carbon 3D, Inc. (Redwood City, CA), for instance as described in U.S. Pat. Nos. 9,205,601 and 9,360,757 (both to DeSimone et al.). For example, in any method described above, selective curing of a photopolymerizable material includes continuous photopolymerization of at least one of the first portion of the article or the second portion of the article.

After a three-dimensional article has been formed, it is typically removed from the additive manufacturing apparatus. At this stage, the three-dimensional article typically has sufficient green strength for handling in any remaining steps of the method. The article surface, as well as the bulk article itself, typically still retain uncured material, suggesting a need for further curing. Removing residual uncured photopolymerizable material is particularly useful when the article is going to subsequently be post-cured, to minimize uncured residual material from undesirably curing directly onto the article. A “cured” article can include a photopolymerizable material that has been at least partially polymerized and/or crosslinked. For instance, in some instances, an at least partially polymerized article is at least about 10% polymerized or crosslinked or at least about 30% polymerized or crosslinked. In some cases, an at least partially polymerized article is at least about 50%, at least about 70%, at least about 80%, or at least about 90% polymerized or crosslinked, for instance between about 10% and about 99% polymerized or crosslinked.

In some examples, removal of excess uncured photopolymerizable composition on the additive manufactured article is at least partially performed by washing with at least one solvent. Suitable solvents include, but are not limited to, propylene carbonate, isopropanol, methanol, di(ethylene glycol) ethyl ether, tripropylene glycol monomethyl ether, diethylene glycol monobutyl ether, a blend of dipropylene glycol monomethyl ether with [2-(2-methoxymethylethoxy)methylethoxy]propanol, and combinations thereof. In certain examples, the removal is performed at least partially by moving the additive manufactured article and thereby generating a mass inertial force in uncured photopolymerizable composition on the article, wherein the mass inertial force is generated using a centrifuge, a shaker, or a mixer that spins along one or more axes. Suitable ways of generating a mass inertial force are described, for instance, in International Publication No. 2020/157598 (Chakraborty et al.), incorporated herein by reference in its entirety. For instance, the source of the mass inertial force may be generated using a centrifuge, a shaker, or a mixer that spins along one or more axes. In some examples, the moving of the object is a rotation or spinning of the object. Accordingly, the mass inertial force may be generated by a centrifugal force. One suitable mixer that spins along more than one axis is a dual asymmetric centrifugal mixer, such as the DAC 400 FVZ available from Flacktek, Landrum, SC. A dual asymmetric centrifugal mixer provides simultaneous dual axis spinning that automatically reorients the article during spinning, which tends to pull uncured composition out of concave features of the article in a short period of time (e.g., 20, 15, or 10 seconds or less). Suitable cleaning solutions are also described in International Publication No. WO 2018/222395 (Jahns et al.)

The methods of the present disclosure also may include subjecting the additive manufactured article to actinic radiation, heat, or both to photopolymerize uncured photopolymerizable composition. Optionally, that can be followed by soaking the article with another solvent (e.g., diethylene glycol ethyl ether or ethanol). Exposure to actinic radiation can be accomplished with any convenient radiation source, generally UV radiation, visible radiation, and/or e-beam radiation, for a time ranging from about 10 seconds to over 60 minutes. Heating is generally carried out at a temperature in the range from about 35 °C to about 80 °C, for a time ranging from about 10 to over 60 minutes in an inert atmosphere, optionally under vacuum. In some examples, post-cure ovens, which combine UV radiation and thermal energy, may be used for post-cure processes. In some examples, post curing may improve the mechanical properties and stability of the three-dimensional article relative to the same three-dimensional article that is not post cured.

In some examples, the photopolymerizable material includes a ceramic material (e.g., ceramic particles and/or ceramic fibers), and the method further includes burning out polymerized material and sintering the additive manufactured article to form a ceramic article.

Regarding any method described above, the steps further optionally include polishing the additive manufactured article, to render at least a portion of a surface of the additive manufactured article smoother than prior to the polishing. Moreover, the methods may further include a treatment of the bonding surface 38 of one or more appliances 30 to improve surface roughness and mechanical retention. Such treatments may include etching, an organo-silane treatment, sandblasting, or any other known mechanical or chemical modification to enhance adhesive bonding between the base 38 and the bonding tooth. For sandblasting, treatment includes blasting the bonding surface with a silica-coated alumina sandblasting medium. A solution of silane (e.g., a silane in ethanol) can then be applied to the treated surface and allowed to dry at room temperature for at least 5 minutes. In the same or other implementations, the base may be bonded to compressible material to assist in filling gaps between the base and the tooth structure. Suitable compressible materials are described in U.S. Pat. No. 9,480,540 (Cinader).

Creating a Transfer Apparatus from a Physical Mockup.

If the physical mockup is generated to satisfaction, a transfer apparatus may be created over said mockup. This may include sending instructions to a pressure forming or thermoforming machine to cause one or more sheets of material to be pressure formed or thermoformed over the physical mockup to form a negative replica or shell. The sheet may be, for example, a sheet of deformable plastic (e.g., an elastic thermoplastic). The sheet of material may be heated to a temperature at which the sheet becomes pliable. Pressure may concurrently be applied to the sheet to form sheet around the mockup. Once the sheet cools, it will have a shape that conforms to the mockup. An interior shape of the plastic shell substantially conforms to the patient's current dental arch. A release agent can be applied to the mockup before forming the plastic shell to facilitate later removal of the plastic shell from the mockup. The shell can be trimmed by laser or mechanical milling techniques to remove excess or unwanted material.

One exemplary method of making a transfer apparatus in the form of a tray includes the use of multiple sheet materials as described in U.S. Pat. No. 10,368,961 (Paehl et al.). The method includes placing elastic sheeting on top of the occlusal side of the teeth represented by the physical mockup, with a plastic sheeting arranged on top of the elastic sheeting. The elastic sheeting and the plastic sheeting are deformed in directions toward the physical mockup. This may be achieved by a vacuum generated beneath the elastic and plastic sheeting or a pressure above the elastic and plastic sheeting. At least the plastic sheeting may be heated before and/or during the deformation. The plastic sheeting is typically allowed to solidify by cooling so as to provide it with a sufficient rigidity for handling.

The method can, in other embodiments, optionally include placing an elastomeric spacer over the physical mockup and thermoforming the hard layer of a transfer apparatus (such as, for example, PETG) over the mockup. The spacer material can be any one of a number of materials including dental putty, a thermoset material, thermoplastics (including nylons), a thermoplastic elastomer, and composites (e.g., glass-filled nylons). Further details regarding the spacer may be found in U.S. Pat. No. 7,762,815 (Cinader et al.)

Optionally, the transfer apparatus may be created having an occlusal stop member, also as described in U.S. Pat. No. 7,762,815. An occlusal stop member typically includes a flat top surface and a bottom surface with shapes such as recesses that match the shapes of the occlusal tips of the patient's dental arch. In certain implementations, the occlusal stop member has a recess or recesses corresponding to only some of the teeth in the dental arch, although it is also possible to construct an occlusal stop member that has one or more recesses corresponding to each tooth of the dental arch. Other variations are also possible. For example, the occlusal stop member may extend only along a portion of the dental arch instead of along the entire dental arch. A plurality of stop members may be provided, potentially spaced apart from each other and optionally connected. The occlusal stop member may be chemically or mechanically bonded to the plastic sheeting and/or the hardenable material.

It should be appreciated that the transfer tray may be formed only of one or more layers of deformable plastic sheeting, without an accompanying elastic sheeting or soft positioning layer. In such implementations, the plastic sheeting may be disposed directly proximate the occlusal surface of the physical mockup, without the spacing provided by elastic sheeting. The plastic sheeting accordingly directly embraces the teeth and appliances of the physical mockup upon deformation, directly creating receptacles used to removably retain appliances for subsequent bonding. In such streamlined transfer apparatus embodiments, the physical mockup may be coated with a release agent to assist in removal of the transfer tray from the mockup. Pursuant to typical methods used to create the transfer apparatus, the resulting tray represents a negative replica of at least a portion of the physical mockup.

Suitable materials for creating a thermoformed transfer apparatus are well known in the art and the selection of material is accordingly not critical. In exemplary implementations, the transfer apparatus is formed from Copyplast™ low density polyethylene, available from Scheu Dental Group, Iserlohn, Germany. Use of transparent materials for the component layers may facilitate confirmation of proper placement of the transfer apparatus and associated appliances on the teeth.

Alternatively, the transfer apparatus may comprise a dental impression material or a bite registration material. A dental impression material can be based on different chemical substances and crosslinked by various chemical reactions (including addition curing and condensation curing materials). Dental impression materials can be classified according to their curing mechanism (e.g., addition curing or condensation curing). Dental impression materials can also be classified according to their consistency. Besides low viscous dental impression materials, there exists highly viscous, so-called putty like dental impression materials. Examples of dental impression material include materials based on alginate(s), hydrocolloids, polysulfides, polyether technology, addition curable silicone materials (e.g., VPS materials) and condensation curable silicone materials. Dental impression materials are typically provided as two component systems that consist of a base paste and a catalyst paste and which are mixed prior to their application. The mixed pastes are typically applied with the help of a syringe-type device.

Dental impression materials are typically characterized by at least one, more or all of the following features: Consistency (according to ISO 4823): comparable low viscosity behavior (consistency 3), a medium viscosity (consistency 1 or 2) or putty-like, highly viscous behavior (consistency 0); Setting time: within about 15 min after mixing at ambient conditions (e.g., 23 °C); Shore A hardness (according to ISO 4823; 24 h): at least about 20 or at least about 40; Tensile strength (according to DIN 53504): at least about 0.2 MPa or at least about 3.0 MPa; Elongation at break (according to DIN 53504): at least about 30% or at least about 150% or at least about 200%; Recovery from deformation (according to ISO 4823): at least about 90% or at least about 95% or at least about 98%. Suitable dental impression materials are also described in EP2072029 (Bissinger et al), U.S. Pat. No. 6,677,393 (Zech et al), EP1512724 (Zech et al), U.S. Pat. No. 6,127,449 (Lechner et al), U.S. Pat. No. 8,007,579 (Klettke et al.) and U.S. Pat. No. 5,569,691 (Guggenberger et al). Suitable dental impression materials are commercially available, e.g., from 3M ESPE under the brands Impregum™ or Imprint™, as well as myriad other suppliers and brands.

In alternative methods, the transfer apparatus may be created through additive manufacturing techniques and the fixture model used to place appliances in the formed transfer apparatus. Suitable methods for designing and additively manufacturing a transfer apparatus can be found, for example, in International Publication Nos. WO2009158231 (Raby et al.) and WO2021130624 (Cinader et al.).

After the transfer apparatus has cured or otherwise solidified, the apparatus is removed from the fixture model. The sprues connecting the appliance to the model may be broken before or during the apparatus removal. The appliances are retained in the apparatus by virtue of at least intimate contact between the transfer apparatus material and the appliance body. As noted above, this contact may be enhanced by retention features on the surfaces of the appliances. The shell can be trimmed by laser or mechanical milling techniques to remove excess or unwanted material before or after removal.

FIGS. 10 and 11 depict a finished transfer apparatus 1100 and a cross-section of one receptacle 1120, respectively. The formed transfer apparatus 1100 (here, a U-shaped tray) substantially matches surfaces of the teeth of the physical mockup. The body of the transfer apparatus 1100 defines a plurality of shells 1150. Each respective shell of shells 1150 is configured to receive an outer surface of a respective tooth. In this way, the transfer tray is configured to align with the dentition of a patient. The inner wall sections of the apparatus 1100 will typically have contours that match the contours of the individual teeth of the patient, as well as an overall configuration that matches the orientation of each tooth relative to other teeth in the same dental arch. The inner wall sections will contact at least two of the labial, occlusal and lingual surfaces of the teeth when seated on the dental arch, though other constructions may omit the one or two of those surfaces.

Each shell of shells 1150 that aligns with a bonding tooth is configured to include a respective receptable 1120 within shells 1150 that is shaped to envelop at least a portion of the respective appliance 1230. In some examples, shell receptacles 1120 may include a feature, such as an undercut or a protrusion, that is configured to engage with a corresponding feature on an appliance 1230. For example, attachment body 1231 may define an undercut (e.g., undercut 1249 created by a retention feature stem 1246 and cap 1248) and a surface of shell recesses 1120 may define a protrusion configured to engage the undercut.

The receptacles 1120 may have any suitable cross-sectional shape or combination of shapes (e.g., trapezoidal, dome-shaped, etc.) but that shape generally corresponds to the shape of associated appliance body 1231, including optional retention stem 1246 and cap 1248. Each receptacle 1120 in the transfer apparatus may each have the same or different cross-sectional shape. In other embodiments, certain groups of receptacles 1120 may include the same cross-sectional shape amongst one another in the group, and have a different cross-sectional shape from the cross-sectional shape of a group situated in a different quadrant or location on the transfer apparatus 1100. In presently preferred circumstances, the apparatus lacks any interior surfaces in the receptacle 1120 disposed between the base of the appliance 1230 and the bonding tooth surface; this configuration may aid in the separation of the appliance 1230 from the transfer tray 1100.

In some embodiments, particularly those trays created from a fixture model including a frame on one or more bonding tooth surfaces, the receptacle may include a channel 1130 at least partially surrounding the receptacle 1120. The channels 1130 may have any suitable cross-sectional shape or combination of shapes (e.g., trapezoidal, dome-shaped, etc.) but that shape generally corresponds to the shape and dimensions of the associated frame. The frame, in such embodiments, creates an indentation in the interior surfaces of the transfer apparatus at the perimeter of the appliance body 1231. The channel 1130 can provide a reservoir for excess adhesive (i.e., flash) that exudes from the area between the appliance base 1238 and the tooth during appliance bonding.

A transfer apparatus need not extend over all exterior surfaces of the appliances. An apparatus may include a combination of such partially exposed appliances, and appliances wholly enveloped in received receptacles. Leaving the appliance 1230 at least partially exposed may, in certain implementations, ease the separation of the appliance 1230 from the transfer apparatus when the appliance 1230 is adequately bonded to the bonding tooth.

Additionally, the transfer apparatus may be used for bonding only a single appliance to a patient's tooth. For example, a portion of the transfer apparatus described above may be used to bond a single appliance to a single tooth subsequent to the time that other appliances are bonded, such as in instances where access to the tooth is initially hindered by other teeth. As another example, a portion of the transfer apparatus described above may be used to re-bond one or more appliances that have unintentionally debonded from the tooth, or to bond a new appliance to a tooth to replace the original appliance.

Adhesive may be applied to one or both of the bonding surface of the appliances 1230 and the patient's tooth surface prior to seating the tray on the patient's dental arch. In some examples, dental adhesive used may include a light-cure adhesive, a chemical cure adhesive, a dual cure adhesive, 3M RELYX Ultimate Adhesive Resin Cement, SCOTCHBOND Universal Adhesive, TRANSBOND XT Primer, TRANSBOND MIP Primer, or APC FLASH-FREE adhesive, all available from 3M Company (St. Paul, Minnesota), or the like. The adhesive may be selected for compatibility with the material used to fabricate the appliance to securely bond attachments onto teeth. After application of adhesive to bonding surfaces, transfer apparatus 1100 may be positioned on the teeth of a patient.

A clinician or any other treating professional may first position transfer apparatus 1100 on dentition. Then, in examples in which the dental adhesive includes a light cure adhesive, the clinician may direct a selected wavelength of radiation, e.g., actinic radiation, toward one or more of appliances 1230 to cause a light-activating resin to set, thereby bonding appliance 1230 to the bonding tooth surface. In other embodiments, the adhesive is a two-part adhesive, with components mixed prior to application of the adhesive to the appliance and/or the teeth. In other examples, the clinician may use an activator or other means to initiate curing of the adhesive immediately before positioning transfer apparatus 1100 on the arch or while transfer apparatus 1100 is positioned on the arch. The teeth may optionally be etched or primed before the transfer tray is seated on the arch.

Once the adhesive is suitably cured, each appliance 1230 may be separated from the associated receptacle 1120. The apparatus is removed from the arch and patient's mouth. The treating professional may then remove any undesired vestiges of the coupling arms.

Kits and assemblies of the appliance described are also contemplated herein. For example, one or more of the attachments described herein may be pre-coated with a suitable orthodontic adhesive and packaged in a container or a series of containers, as described for example in U.S. Pat. No. 4,978,007 (Jacobs et al.); U.S. Pat. No. 5,015,180 (Randklev); U.S. Pat. No. 5,429,229 (Chester et al.); and U.S. Pat. No. 6,183,249 (Brennan, et al.), and U.S. Patent Publication No. 2008/0286710 (Cinader et al.).

Various techniques of this disclosure may be implemented in a wide variety of computer devices, such as servers (including the Cloud), laptop computers, desktop computers, notebook computers, tablet computers, hand-held computers, smart phones, and the like. Any components, modules or units have been described to emphasize functional aspects and does not necessarily require realization by different hardware units. The techniques described herein may also be implemented in hardware, software, firmware, or any combination thereof. Any features described as modules, units or components may be implemented together in an integrated logic device or separately as discrete but interoperable logic devices. In some cases, various features may be implemented as an integrated circuit device, such as an integrated circuit chip or chipset.

If implemented in software, the techniques may be realized at least in part by a non-transitory computer-readable medium comprising instructions that, when executed in a processor, performs one or more of the methods described above. The computer-readable medium may comprise a tangible computer-readable storage medium and may form part of a computer program product, which may include packaging materials. The computer-readable storage medium may comprise random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The computer-readable storage medium may also comprise a non-volatile storage device, such as a hard-disk, magnetic tape, a compact disk (CD), digital versatile disk (DVD), Blu-ray disk, holographic data storage media, or other non-volatile storage device. The term “processor,” as used herein may refer to any of the foregoing structure or any other structure suitable for implementation of the techniques described herein. In addition, in some aspects, the functionality described herein may be provided within dedicated software modules or hardware modules configured for performing the techniques of this disclosure. Even if implemented in software, the techniques may use hardware such as a processor to execute the software, and a memory to store the software. In any such cases, the computers described herein may define a specific machine that is capable of executing the specific functions described herein. Also, the techniques could be fully implemented in one or more circuits or logic elements, which could also be considered a processor.

The patents, patent documents, and patent applications cited herein are incorporated by reference in their entirety as if each were individually incorporated by reference. Although specific embodiments of the present disclosure have been shown and described herein, it is understood that these embodiments are merely illustrative of the many possible specific arrangements that can be devised in application of the principles of the present disclosure. Numerous and varied other arrangements can be devised in accordance with these principles by those of ordinary skill in the art without departing from the spirit and scope of the present disclosure. Thus, the scope of the present disclosure should not be limited to the structures described in this application, but only by the structures described by the language of the claims and the equivalents of those structures.

1. A physical mockup for creating a transfer apparatus, the mockup comprising:
a representation of at least a portion of a dental arch of a patient, the dental arch including a plurality of teeth, each tooth including at least two of an occlusal surface, a lingual surface, and a labial surface, at least one of the occlusal, lingual, and labial surfaces defining a bonding surface;
wherein one or more teeth include an appliance frangibly connected to said tooth at the bonding surface of said tooth, each tooth with a connected appliance defining a bonding tooth; and
wherein the appliance is coupled at the bonding surface via one or more sprues.

2. (canceled)

3. The mockup of claim 1, wherein the sprues extend between a base of the appliance and the bonding surface.

4. The mockup of claim 1, wherein the appliance and at least one tooth are comprised of the same material.

5. The mockup of claim 1, wherein the appliance and at least one tooth are formed by three-dimensional printing.

6. The mockup of claim 1, wherein a portion of the appliance is received in a recess in the bonding surface.

7. The mockup of claim 6, wherein the base of the appliance is received in the recess.

8. The mockup of claim 7, wherein the recess includes a shape complemental to a shape of the orthodontic appliance.

9. The mockup of claim 1, wherein the recess includes one or more ledges located adjacent the base of the appliance, each ledge providing a stop surface.

10. The mockup of claim 1, wherein the recess includes a least two ledges, each ledge on an opposing side of the recess.

11. The mockup of claim 1, and further comprising a frame at least partially surrounding the aperture.

12. The mockup of claim 11, wherein the frame projects outwardly from bonding tooth surface.

13. The mockup of claim 11, wherein a bonding base of the appliance is located relatively nearer the interior of the mockup than an outer surface of the frame.

14. A method for creating a transfer tray for one or more orthodontic appliances, the method comprising:
providing a physical mockup for creating a transfer apparatus, the mockup comprising:
a representation of at least a portion of a dental arch of a patient, the dental arch including a plurality of teeth, each tooth including at least two of an occlusal surface, a lingual surface, and a labial surface;
wherein one or more teeth include an appliance frangibly connected to said tooth at the bonding surface of said tooth, each tooth with a connected appliance defining a bonding tooth; and
forming a tray over the mockup.

15. The method of claim 11, and further comprising removing the tray from the mockup.

16. The method of claim 12, wherein removing the tray from the mockup includes the step of separating the appliance from the mockup.

17. The method of claim 13, wherein separating the appliance from the mockup includes breaking one or more sprues.

18. The method of claim 13, wherein one or more bonding teeth include an aperture at least partially beneath the appliance.

19. The method of claim 18, wherein the aperture contains at least one tooth providing a stop surface, and wherein separating the appliance from the mockup includes breaking one or more sprues and allowing a portion of a base of the appliance to contact the stop surface.

20. A system for indirect bonding of orthodontic appliances, the system comprising:
a transfer body defining a shell configured to receive an outer surface of a tooth of a dental arch and including an interior surface substantially conforming to the contour of at least one tooth of the dental arch, wherein the transfer body defines at least one recess within the shell; and
an orthodontic appliance, the appliance including a base for bonding the appliance to the tooth and a body including a perimeter;
wherein a least a portion of the perimeter is surrounded by a channel in the transfer body.

21. The system of claim 20, wherein the appliance body has a shape of an orthodontic attachment configured to transfer a force from a clear tray aligner to the tooth.

22. The system of claim 20, wherein the appliance is an orthodontic bracket.

23. The system of claim 20, wherein the transfer body includes a thermoformed material.

24. The system of claim 20, wherein the transfer body includes an impression material.

25. The system of claim 20, wherein the channel entirely surrounds the appliance perimeter.
